(19) United States
(12) Patent Application Publication
(10) Pub. No.: US 2026/0270300 A1
(43) Pub. Date: Sep. 10, 2026

(54) METHODS, IMS NODE AND SERVER FOR HANDLING COMMUNICATION IN A COMMUNICATION NETWORK

(71) Applicant: Telefonaktiebolaget LM Ericsson (publ), Stockholm (SE)

(72) Inventors: Andreas Anulf, Lidingö (SE); Bo Burman, Upplands Väsby (SE); Mattias Dahlqvist, Stockholm (SE); Michael Lindström, Tullinge (SE); Mats Stille, Bromma (SE)

(21) Appl. No.: 19/114,896

(22) PCT Filed: Sep. 28, 2022
(86) PCT No.: PCT/EP2022/077008

§ 371 Date: Mar. 25, 2025

(51) Int. Cl. H04L 65/1016

(52) U.S. Cl. CPC H04L 65/1016

(57) ABSTRACT

Embodiments herein relate to, for example, a method performed by an Internet Protocol Multimedia Subsystem (IMS) node for handling communication in a communication network. The IMS node adds an indication to a request of a User Equipment (UE), wherein the request relates to a session of an IMS service, and wherein the indication identifies a user of the UE and the session. The IMS node transmits the request to a server including the indication.

### TECHNICAL FIELD

Embodiments herein relate to an IMS node, a server, and methods performed therein regarding wireless communication. Furthermore, a computer program and a computer-readable storage medium are also provided herein. In particular, embodiments herein relate to handling communication, such as Internet Protocol (IP) Multimedia Subsystem (IMS) sessions, in a communication network.

### BACKGROUND

In a typical communication network, user equipments (UE), also known as terminals, wireless communication devices, mobile stations, stations (STA) and/or wireless devices, communicate via a Radio Access Network (RAN) with one or more core networks (CN). The RAN covers a geographical area which is divided into service areas or cell areas, with each service area or cell area being served by radio network node such as an access node e.g. a Wi-Fi access point or a radio base station (RBS), which in some networks may also be called, for example, a NodeB, a gNodeB, or an eNodeB. The service area or cell area is a geographical area where radio coverage is provided by the radio network node. One or more radio network nodes operate on radio frequencies to communicate over an air interface with the UEs within range of the radio network node. Respective radio network node communicates over a downlink (DL) to the UE and the UE communicates over an uplink (UL) to the respective radio network node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases, such as 6^{th} generation (6G) networks and development of 5G such as New Radio (NR). The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the 5G technologies such as NR, the use of very many transmit-and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

The Internet Protocol (IP) Multimedia Subsystem (IMS) is a well-known 3GPP standard allowing sessions to be setup between two or more parties for a broad variety of services such as voice or video call, interactive messaging sessions or third-party specific applications. A protocol chosen by 3GPP is the Session Initiation Protocol (SIP). The SIP provides a mechanism for registration of UEs and for setting up multimedia sessions. The SIP REGISTER method enables the registration of user agent's current location and the SIP INVITE method enables the setting up of a session. IMS is implemented by Public Land Mobile Network (PLMN) operators as an architectural framework for delivering IP multimedia services to their subscribers.

There is an ongoing standardization of IMS data channel within GSMA and 3GPP. The main objective with an IMS data channel is to provide web application-based values to conversational 5G voice over LTE (VOLTE) multimedia telephony (MMTel) sessions. The ambition is that standard web applications as today consumed by users over the Internet, also shall be available within the 5G voice over NR (VONR) MMTel conversation.

The bootstrap application as defined by 3GPP TS 26.114 is a web application and as such it can interact with content and web servers located in the Internet domain. As per the existing preliminary technical 3GPP SA2 NG-RTC study (3GPP TR 23.700-87), media of bootstrap data channels within an IMS MMTel session, must be relayed between the data channel Multimedia Telephony Service for IMS (DCMTSI) UE and the IMS Data Channel Signaling Function (DCSF) hosting the web server. Such interworking requires transport level interworking between the IMS system and the web server due to the differences in the transport layer. The GSMA ‘NG.129 IMS Data Channel White Paper’ has defined a function named Data Channel Gateway (DCGW) to perform this transport level interworking between web real time communication (WebRTC) data channels and the hypertext transport protocol (HTTP) web server as per the below media protocol stack overview.

FIG. 1 DC Gateway protocol conversion of bootstrap media, from NG.129 Annex A.1.

The DCSF may offer different bootstrap applications per user based on type of subscription and need consequently be able to identify to whom a specific bootstrap channel belongs.

The current architectural view of 3GPP TR 23.700-87, have modeled the DCGW function as being a sub-function of the Data Channel Media Function (DCMF) provided by an enhanced Media Resource Function (MRF) or as a standalone DCMF network function (NF). The media interface between the MRF and the DCSF, logically an interface between the IMS and the data network domains, is referred to as ‘MDC1’ as per in FIG. 2.

The transport protocol layer between web browsers and web servers on Internet is presented below as a reference of interest for this disclosure. FIG. 3 shows HTTP Transport protocols between browsers and servers on Internet.

The interaction between the web browser, i.e., the UE, and the web server is typically stateless as a request/response transaction, i.e., the web browser sends an HTTP request targeting a specific resource which the web server responds to. The request/response may carry information identifying served user within the web server application.

A web server on the Internet serves a huge number of users on a single public IP address and transport control port (TCP) port (typically port 80), which implies that the server can handle many client requests of different users simultaneously. Each individual request received by the server, which needs be responded, is uniquely identified by the TCP/IP connection used i.e., the 5-tuple {source IP address, source TCP port, destination IP address, destination TCP port, protocol in use}.

A web browser client may setup a new TCP/IP connection per request/response transaction, i.e., the web browser allocates a new ephemeral source TCP port per request sent. Some browsers clients may re-use an already established TCP connection for subsequent requests.

In some cases, the basic assumption that each HTTP request is independent from other requests does not fully hold. One example case is when the web server requires the client to use some type of authentication to access the content, which should (for usability purposes) not be required for each individual HTTP request but let a single authentication action apply for several subsequent requests, typically until some inactivity or timeout is reached. This “being authenticated” property introduces a state, a kind of “session” concept, to each subsequent HTTP request after a successful authentication, and is typically solved by the web server by both saving and being able to retrieve this state as a so-called “cookie” in the individual web client storage space. That solution to keep browsing (“session”) state avoids less desirable approaches, such as statically allocating a server port per served web client that would require excessive use of limited port resources.

For the use of web and HTTP technology as content in IMS data channels, the current ambitions of 3GPP SA2 NG-RTC study described by 3GPP TR 23.700-87 are to:
1) Allow use of standard web servers as bootstrap application content providers for the IMS data channel.
2) Have the possibility to provide different bootstrap applications per served IMS subscriber based on type of subscription.
3) Let each DCSF/web server, serve as many users as possible (millions?), with each user potentially having multiple UE's, which each, potentially involved in up to three MMTel sessions, which each has a web browser instance with up to N number of application tabs (bootstrap data channels) started as per the following cardinality overview.

FIG. 4 shows cardinality between active bootstrap data channel web sessions and a single DCSF instance.

The 3GPP SA2 NG-RTC study has not yet specified how the above ambitions can be fulfilled over the ‘MDC1’ interface.

### SUMMARY

As part of developing embodiments herein one or more problems have been identified. For the use of web and HTTP technology as content in IMS data channels, the client-to-web-server transport stack, see FIG. 1, looks a bit different than the regular web browser and web server, see FIG. 3. The DCGW function is a single IP client, with a limited number of source IP addresses (interfaces), serving a huge number of DCMTSI IP clients as opposed to standard web browsers on the Internet where each user host (PC, laptop, mobile etc) has a unique IP address. Each IP interface of the DCGW can be used for a maximum of 64K simultaneous sessions (limited by the source TCP port range). There, separating different requests simply based on the 5-tuple as described is possible but would then require use of many IP interfaces, dimensioned for the busy hour traffic intensity, and would consequently have a low utilization in average.

A tentative solution to the above problem could be to use Stream Control Transmission Protocol (SCTP) data channels as transport protocol between the DCGW and the web server. But such solution would require development of a new IMS data channel specific web server function, which most likely still would be in the need of an internal DCGW-like function in order to allow re-use of standard web components.

A traditional web server can identify a specific web client user by requesting authentication as part of the started web application. In IMS, each UE is identified as belonging to (be used by) a specific subscriber at registration time, which is a prerequisite for initiation of telephony communication with remote parties.

The mechanism specifying how a standard web server identifies a specific IMS subscriber when receiving the initial HTTP request to fetch the welcome page of the bootstrap applications, is currently undefined. It must here be possible for the webserver to identify the subscriber already when receiving the initial HTTP request on a bootstrap channel, since every subscriber may have different types of applications depending on both subscription profile and personal preference.

A tentative solution to the above problem could be to let the DCMTSI terminal and/or DCMTSI web browser implementation append the identity of the IMS subscriber as context meta-data at bootstrap data channel web session establishment time. However, such solution could potentially be compromised by malicious software and result in use of fraudulent identities. Current practice in IMS is to never trust identities provided over the user network interface (UNI), unless being asserted by the network. An object herein is to provide a mechanism to enable communication, for example, handle data channel communication of an IMS session, in an efficient manner in a communication network.

According to an aspect the object is achieved by providing a method performed by an IMS node, such as a DCGW, for handling communication in a communication network. The IMS node adds an indication to a request of a UE, wherein the request relates to a session of an IMS service, and wherein the indication identifies a user of the UE and the session. The IMS node transmits the request to the server, including the indication.

According to another aspect the object is achieved by providing a method performed by a server for handling communication in a communication network. The server receives a request relating to a session of an IMS service, from an IMS node, with an indication identifying a user of the UE and the session.

According to yet another aspect the object is achieved by providing an IMS node, and a server configured to perform the methods herein, respectively.

Thus, according to an aspect the object is achieved by providing an IMS node, such as a DCGW, for handling communication in a communication network. The IMS node is configured to add an indication to a request of a UE, wherein the request relates to a session of an IMS service, and wherein the indication identifies a user of the UE and the session. The IMS node is further configured to transmit the request to the server, including the indication.

According to still another aspect the object is achieved by providing a server for handling communication in a communication network. The server is configured to receive a request relating to a session of an IMS service, from an IMS node, with an indication identifying a user of the UE and the session.

It is furthermore provided herein a computer program product comprising instructions, which, when executed on at least one processor, cause the at least one processor to carry out the methods herein, as performed by the IMS node and the server, respectively. It is additionally provided herein a computer-readable storage medium, having stored thereon a computer program product comprising instructions which, when executed on at least one processor, cause the at least one processor to carry out the methods herein, as performed by the IMS node and the server, respectively.

It is herein disclosed methods for the IMS node, such as a DCGW, to append the indication, such as a subscriber and session unique meta data, to an initial request of each established bootstrap data channel, enabling the server, such as a DCSF/standard web server, to identify both the served user and session, such as a bootstrap data channel web session. The server may then represent an indication as routing information, for example, the meta data as a standard web cookie, to identify the session for subsequent requests.

Embodiments herein enable the server to serve and identify a large number of IMS sessions, such as bootstrap data channel web sessions, simultaneously. Thus, embodiments herein enable a communication, e.g., handle or manage IMS sessions comprising DC content, in an efficient manner in the communication network.

### BRIEF DESCRIPTION OF THE DRAWINGS

Embodiments will now be described in more detail in relation to the enclosed drawings, in which:

FIG. 1 shows a DC Gateway protocol conversion of bootstrap media, from NG. 129 Annex A. 1 according to prior art;

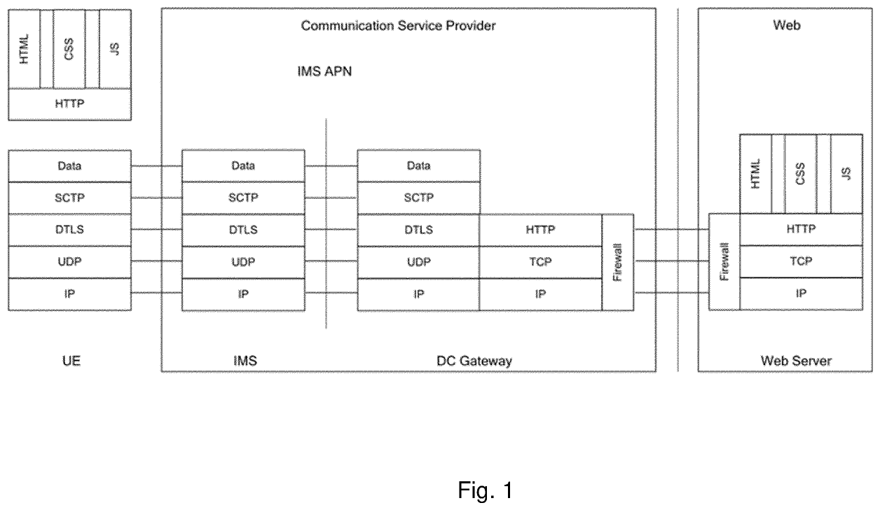

FIG. 2 shows an Agreed architecture for IMS data channel usage of 3GPP TR 23.700-87 according to prior art;

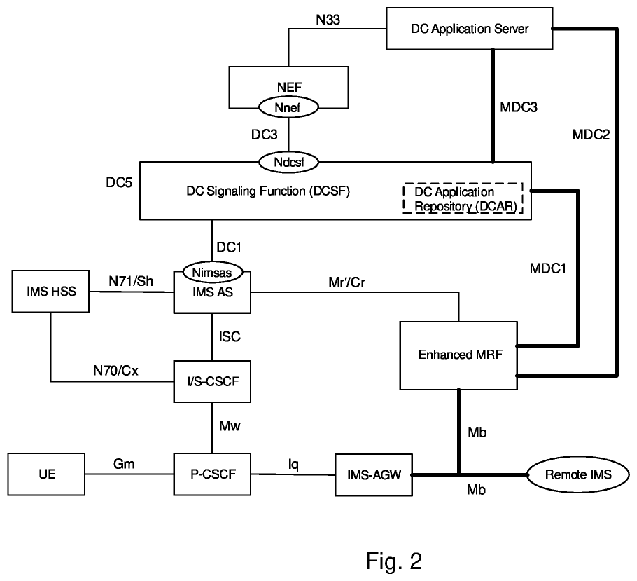

FIG. 3 shows HTTP Transport protocols between browsers and servers on Internet according to prior art;

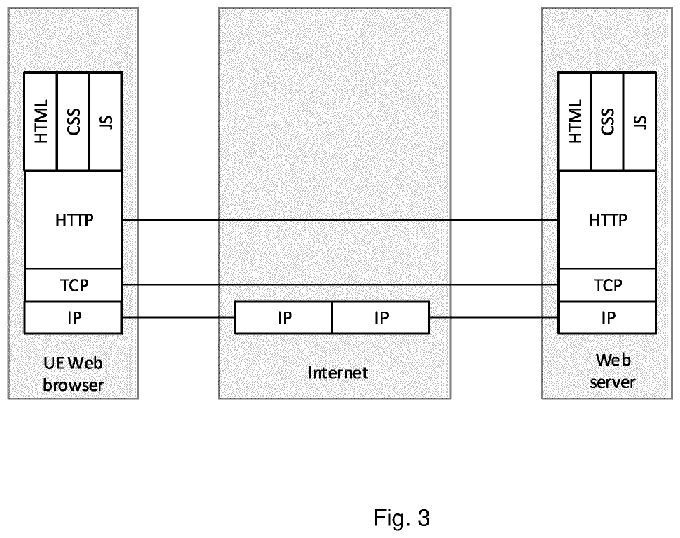

FIG. 4 shows a cardinality between active bootstrap data channel web session and a single DCSF instance according to prior art;

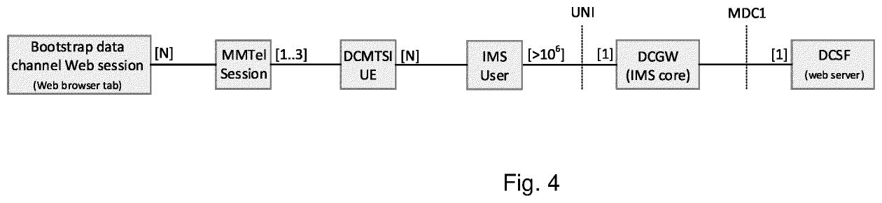

FIG. 5 shows an overview depicting a communication network according to embodiments herein;

FIG. 6 shows a combined signalling scheme and flowchart depicting embodiments herein;

FIG. 7 shows a flowchart illustrating a method performed by an IMS node according to embodiments herein;

FIG. 8 shows a flowchart illustrating a method performed by a server according to embodiments herein;

FIG. 9 shows an example of bootstrap context meta-data and multiplexing within single TCP connection according to embodiments herein;

FIG. 10 shows an example of web cookie representation according to embodiments herein;

FIG. 11 shows a block diagram depicting embodiments of an IMS node according to embodiments herein; and

FIG. 12 shows a block diagram depicting embodiments of a server according to embodiments herein.

### DETAILED DESCRIPTION

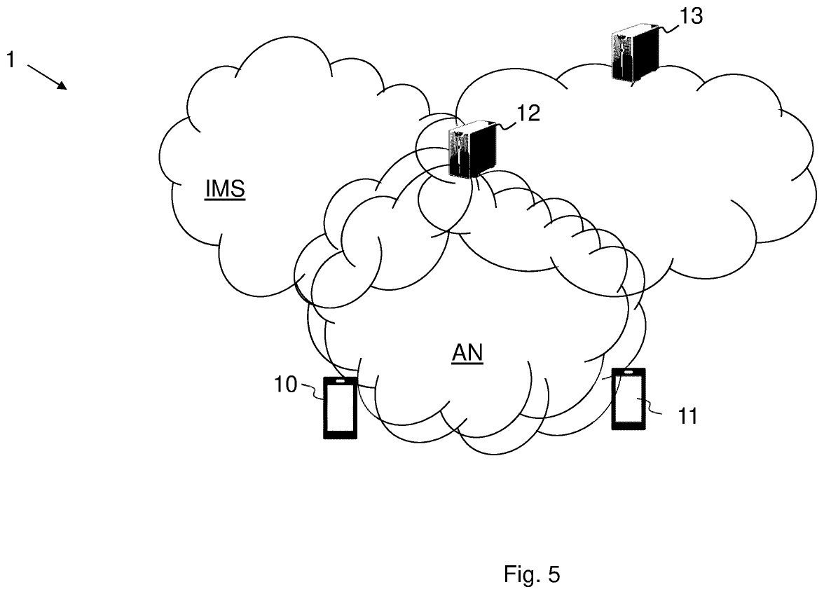

Embodiments herein relate to communication networks in general. FIG. 5 is a schematic overview depicting a communication network 1. The communication network 1 comprises one or more access networks such as RANs and one or more CNs. The communication network 1 may use one or a number of different technologies.

Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the communication network 1, a first UE 10 such as a mobile station, a wireless device, a non-access point (non-AP) STA, a STA, and/or a wireless terminal, is comprised communicating via e.g. one or more Access Networks (AN), e.g. RAN, to one or more core networks (CN). The first UE 10 may be communicating with a second UE 11. The first and the second UE are referred to herein as UE 100. It should be understood by the skilled in the art that “UE” is a non-limiting term which means any terminal, wireless communications terminal, user equipment, Internet of things (IoT) capable device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node. The first UE 10 may be referred to as originating UE and the second UE 11 may be referred to as terminating UE.

The communication network 1 provides IMS services, such as voice over LTE (VOLTE), Voice over NR (VONR), or similar, and comprises an IMS node 12. The IMS node 12 may be an IMS gateway towards a server 13 in a web domain, such as a web server or a DCSF entity. Embodiments herein relate to handling an IMS session between UEs in the communication network 1. Embodiments herein enable use of standard web servers to offer bootstrap applications for the 3GPP IMS data channel architecture. Thus, embodiments herein relate to a session such as a bootstrap data channel web session, being a web application presented to the user in a web browser tab of the UE, connected to the web server domain via a webrtc bootstrap data channel of an IMS session.

The IMS node 12 may comprise a DCGW function being a gateway responsible for media interworking between the IMS data channel and the web domains. By having the DCGW function emulate being a standard web server client, standard web servers can be used to offer IMS data channel applications. Since a huge number of IMS subscribers may be served by one and the same IMS node 12, each individual establishment of a bootstrap data channel web session, needs to include a unique indication such as unique context meta-data to allow the server 13 to identify to which served IMS subscriber and bootstrap data channel web session, such request originates from. Once having received the indication of the initial request of a new bootstrap data channel web session establishment, the server 13 may append a web cookie to the response identifying the web session context at subsequent requests. The web cookie may comprise a session ID indicating the bootstrap data channel web session such as a bootstrap data channel web session ID.

As a result of having the indication such as meta-data being appended to each request, e.g., HTTP request, interface resources between the IMS node 12 and the server 13, e.g., TCP connections, can be shared and re-used by web sessions of all served IMS subscribers being multiplexed simultaneously across one and the same interface and port. HTTP/2 or HTTP/3 (or other multiplexing techniques) in the interface between the IMS node 12 and the server 13 may be used in order to avoid head-of-line blocking, which will be an issue when multiplexing different HTTP/1.1 requests over one and the same TCP connection, but it is not a pre-requisite for embodiments herein.

The proposed solution specifies use of standard mechanisms in the context of IMS data channel, enabling an individual server to serve and identify a large number of IMS sessions, such as bootstrap data channel web sessions, simultaneously. Furthermore, full flexibility is provided in usage of available interface resource/transport connections, such as TCP connections, between the IMS node 12 and one or more servers. Any resources can be used by any bootstrap data channel web session of any IMS subscriber, which hereby: improves resource utilization in the media interface, simplifies session retainability in failure scenarios, and/or facilitates scaling of resources when the subscriber usage of the IMS data channel provided applications grows.

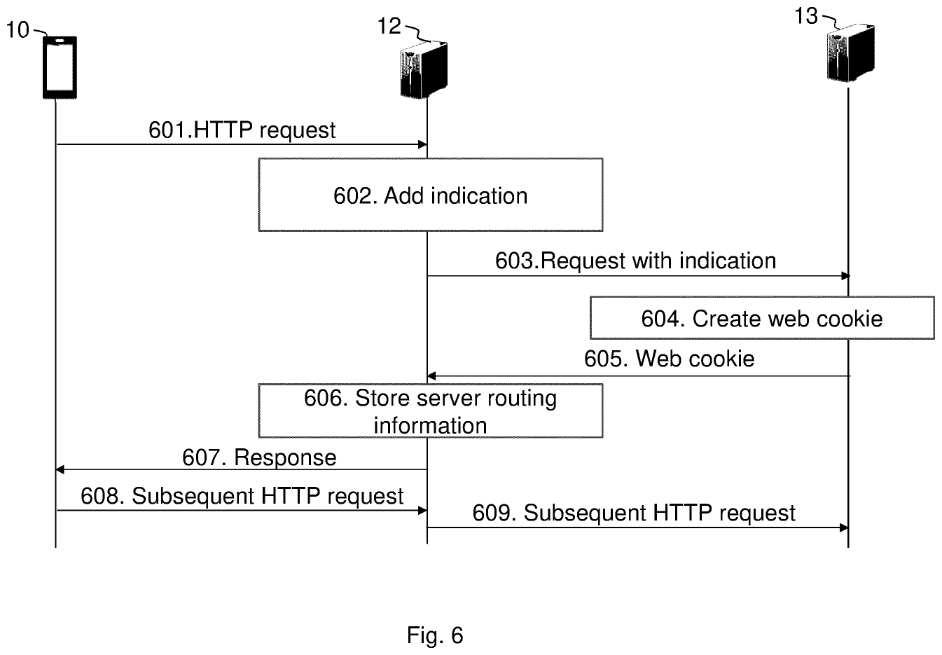

FIG. 6 shows a combined flowchart and signalling scheme according to some embodiments herein.

The UE, for example, the first UE 10 and/or the second UE 11 may establish one or more data channels towards the indicated network domain, to obtain content over said data channels. A bootstrap data channel may be established between the UE 10 and the IMS node 12 during either the call setup phase or once the call is established.

Action 601. The UE 10 may transmit towards a server of a network domain such as a Web server, a request relating to a session of an IMS service, such as an HTTP request of a bootstrap data channel web session establishment.

Action 602. The IMS node 12 adds an indication to the HTTP request, wherein the indication identifies IMS user of the UE 10 and the session. The IMS node 12 may add context meta data to the HTTP request mapped to the bootstrap data channel web session. The indication may be a unique ID such as meta data identifying a bootstrap data channel web session and may comprise identity of the subscriber (user) registered by the UE 10, SIP Session-ID uniquely identifying the call session of the subscriber, and/or bootstrap context. The meta data may be a (condensed) representation of:
1) served user identity
2) (IMS/MMTel) Call session identity (uniquely identifying the session on a specific UE)
3) Bootstrap data channel (carrying the HTTP request)

Action 603. The IMS node 12 forwards the received request to the server 13, for example, using an available HTTP/2 stream, including the indication such as the meta-data comprising path parameters, identifying the subscriber, data channel, and/or session.

Action 604. The server 13 creates a web cookie identifying the session such as the bootstrap data channel web session, which web cookie may be used in subsequent requests sent by the UE 10. The web cookie may comprise a session ID such as a bootstrap data channel web session ID.

Action 605. The server 13 transmits the web cookie to the IMS node 12. For example, the server 13 may return a unique web cookie to the browser client, representing the web application session, which is to be used in subsequent requests within the same bootstrap data channel web session.

Action 606. The IMS node 12 may store server routing information as meta-data within HTTP layer, as the web cookie or another web cookie. Thereby, realization of a routing function can be simplified since each request would include all information required to route the request to the web server currently serving the IMS subscriber and the bootstrap data channel web session.

Action 607. The IMS node 12 may then transmit a response to the UE 10 and may append the web cookie or the other web cookie, identifying the server instance serving this specific data channel session. The appended web cookie may comprise a bootstrap data channel web session ID of the IMS node and/or session ID of the server.

Action 608. The UE 10 may then transmit a subsequent HTTP request, with the web cookie, to the IMS node 12 within the bootstrap data channel.

Action 609. The IMS node 12 forwards the received HTTP request to the server 13 as specified in the web cookie from the UE.

By having the IMS node to represent the mapping of each individual IMS subscriber data channel to a specific interface and protocol stream towards the DCSF as a web cookie, which the UE will use in each subsequent HTTP request, a large number of sessions such as bootstrap data channel web sessions of IMS subscribers may be multiplexed simultaneously across one and the same DCGW IP interface and port.

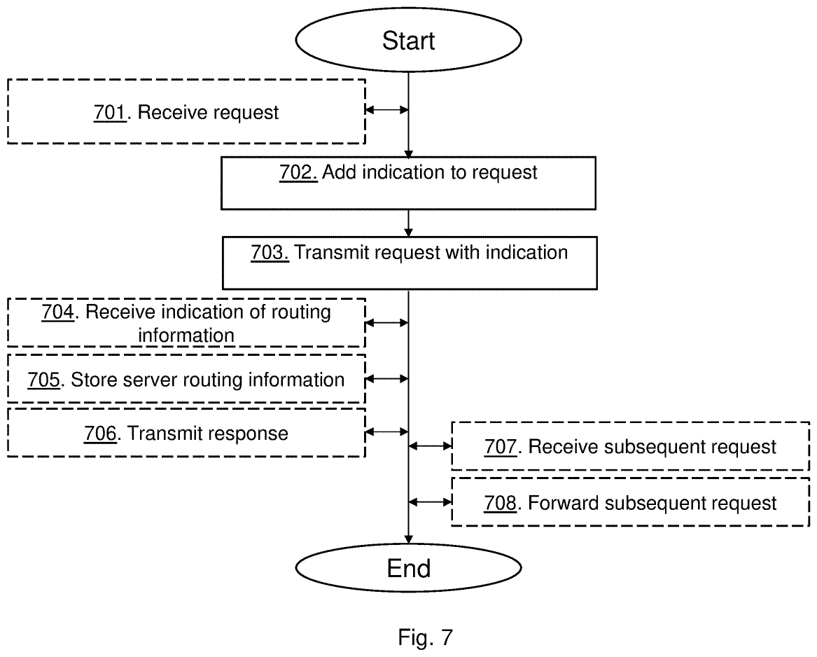

FIG. 7 illustrates an example of a method performed by the IMS node 12 for handling communication in the communication network 1. Optional actions are marked with dashed boxes and/or actions may be taken in any suitable order.

Action 701. The IMS node 12 may receive from the UE 10, a request such as an HTTP request, of a bootstrap session.

Action 702. The IMS node 12 adds an indication to the request/or another request, wherein the request relates to a session of an IMS service, and wherein the indication identifies user of the UE 10, or IMS user of the UE, and the session. The session may comprise a bootstrap data channel web session. The IMS node 12 may add meta data, being the indication, to the request mapped to the session. The meta data may comprise one or more of the following: an identity related to the UE, an identity of a call session, and/or a bootstrap context. Thus, the indication may comprise identity of the subscriber (user) registered by the UE, SIP Session-ID uniquely identifying the call session of the subscriber, and/or bootstrap context such as bootstrap data channel web session ID.

Action 703. The IMS node 12 forwards or transmits the request to the server 13, for example, using an available HTTP/2 stream, including the indication, such as the meta-data comprising path parameters, identifying the subscriber, data channel, and/or session. The IMS node 12 may transmit requests from more than one UE multiplexed using a same interface and port. For example, the IMS node may multiplex requests from users within a single TCP connection towards the server 13.

Action 704. The IMS node 12 may receive from the server 13 an indication of routing information, such as the web cookie, identifying the session such as a bootstrap data channel web session, which indication is to be used in subsequent requests sent by the UE 10.

Action 705. The IMS node 12 may store server routing information as meta-data within HTTP layer, such as a web cookie or another web cookie. Thereby, realization of a routing function can be simplified since each request would include all information required to route the request to the web server currently serving the IMS subscriber and the bootstrap data channel web session.

Action 706. The IMS node 12 may then transmit a response to the UE 10 with an appended indication, for example, the server routing information such as the web cookie, identifying the server instance serving the session such as a data channel session or bootstrap data channel web session.

Action 707. The IMS node 12 may then receive from the UE 10 a subsequent request with the (previously appended) indication. For example, the IMS node 12 may receive a HTTP request within the bootstrap data channel with the web cookie.

Action 708. The IMS node 12 may forward the received subsequent request to the server 13 as specified in the indication, such as the web cookie, from the UE 10 with the indication of routing information, e.g., the web cookie from the server 13.

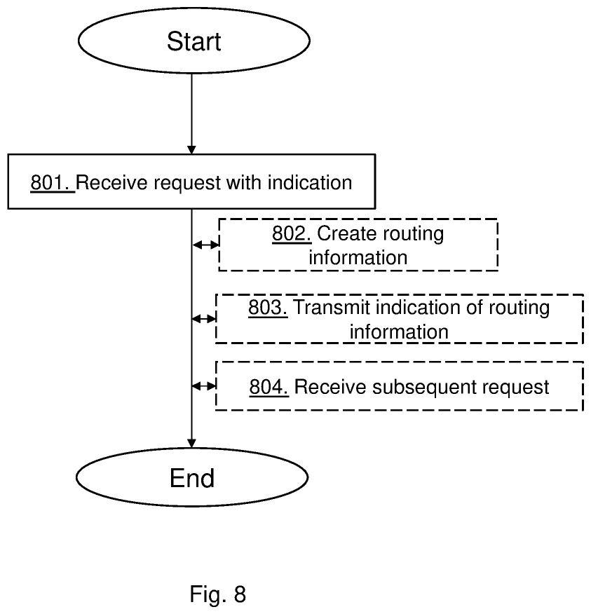

FIG. 8 illustrates an example of a method performed by the server 13 for handling communication in the communication network. Optional actions are marked with dashed boxes and/or actions may be taken in any suitable order.

Action 801. The server 13 receives the request from the IMS node 12, for example, using an available HTTP/2 stream, including the indication. The request relates to the session of the IMS service, and the indication identifies the user of the UE 10, or IMS user of the UE, and the session. The session may comprise a bootstrap data channel web session. The indication may comprise meta-data comprising path parameters, identifying the subscriber, data channel, and/or session.

Action 802. The server 13 may create routing information such as the web cookie identifying the bootstrap data channel web session, which is to be used in subsequent requests sent by the UE 10.

Action 803. The server 13 may transmit the indication of routing information, such as the web cookie, to the IMS node 12.

Action 804. The server 13 may further receive a subsequent request from the IMS node comprising the indication of the created routing information. For example, the server may receive the subsequent request from the IMS node 12 with a web cookie enabling the server 13 to identify the subsequent request to the session and IMS user.

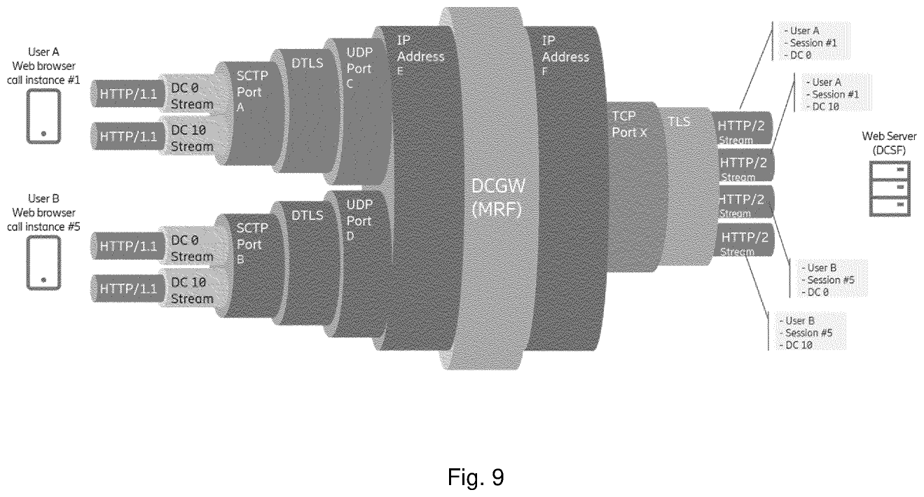

The following FIG. 9 presents a high-level example of meta data or context meta-data and multiplexing within a single TCP connection towards the web server (here represented by ‘Port x’ on interface ‘IP Address F’).

As visualized by the FIG. 9, each DC stream is mapped by the IMS node 12 such as a DCGW function, to an available HTTP/2 stream at bootstrap data channel web session establishment, appended with context meta-data identifying served IMS subscriber and bootstrap data channel web session.

A similar approach to HTTP/2 (as described by the right-hand side of the FIG. 9) is possible with HTTP/3, which uses User Datagram Protocol (UDP) and Quick UDP Internet Connections (QUIC) transport with multiple QUIC streams instead of TCP/transport layer security (TLS) and multiple HTTP/2 streams. The approach described herein is therefore very likely compatible, with minor changes, with future web servers supporting HTTP/3.

In addition to the responsibility of appending the indication such as context meta-data to an initial HTTP request of each bootstrap session establishment, the IMS node 12 is also responsible for relaying each request to the appointed web server for the IMS subscriber. By storing web server routing information as meta-data within the HTTP layer, as a web cookie, realization of the routing function can be simplified since each request would include all information required to route the request to the web server currently serving the IMS subscriber and that specific bootstrap data channel web session.

A DCMTSI UE such as the UE 10 may, as stated by 3GPP TS 26.114, issue a HTTP GET request on the root resource element once a bootstrap data channel is established.

Example of request:
Get/index. html HTTP/1.1

A WebRTC bootstrap data channel, is established between the DCMTSI UE and the DCGW sub-function during either the call setup phase or once the call is established.

An established WebRTC data channel is uniquely carrying bootstrap application media within a specific web browser context of a specific call session of a specific DCMTSI UE of a specific IMS subscriber. By providing the DCGW function with source of origin information per WebRTC data channel, this information can be appended as meta-data to the initial HTTP request forwarded to the web server such as a DCSF.

The meta-data shall include at least one or more of the following information:
Served and or asserted identity of the subscriber (user) registered by the DCMTSI UE
SIP Session-ID uniquely identifying the call session of the subscriber (user)
WebRTC data channel identity (bootstrap context)

The server 13 may provide different types of applications per IMS subscriber, depending on service assignment and potentially also subscriber individual preference.

The provided meta-data of the initial HTTP request, appended by the IMS node 12, is sufficient for the web server to identify exactly which subscriber and call session and data channel being served. Having received identification of the served subscriber session and bootstrap session accessed by the initial GET request from the DCMTSI UE, the server can return a unique web cookie to the browser client, representing the bootstrap data channel web session, which must be used in subsequent requests within the same session.

The meta-data is typically expressed as a resource path extension to the HTTP URL i.e. as input parameters of a general bootstrap session.

The following example presents the HTTP signaling of an established bootstrap data channel of a specific call, and how the IMS node 12 appends meta-data to the initial request as bootstrap root parameters and the use of web cookies in subsequent requests. The IMS node 12 is represented by a DCGW and the server is represented by a DCSF.
1) DCGW receives the initial HTTP request from the DCMTSI UE on an established bootstrap data channel:
   Get/index. html HTTP/1.1
   Host: <no value or omitted>
2) DCGW forwards the received HTTP request to the appointed DCSF, using an available HTTP/2 stream, including meta-data as path parameters, identifying the subscriber, data channel, and session:
   GET/index. html; subscriber=<subscriber identity>; dc=<data channel
   id>; sessionId=<session-ID>HTTP/2
   Host: <DCSF 1>:3365
3) DCSF, i.e. the server 13, responds to the request including a web cookie identifying this specific bootstrap session, which must be used in subsequent requests sent by the UE:
   HTTP/2 200 OK
   Content-Type: . . .
   Set-Cookie: bsApplSession=<unique bootstrap (BS) data channel web session identity>
   [page content]
4) DCGW forwards the response to the DCMTSI UE and appends a web cookie identifying the DCSF instance serving this specific data channel session:
   HTTP/2 200 OK
   Content-Type:
   Set-Cookie: bsApplSession=<unique BS data channel web session identity>
   Set-Cookie: dcgwSession=<unique DCGW session identity>
   [page content]
5) DCGW receives a subsequent HTTP request from the same DCMTSI UE within the bootstrap data channel:
   POST /myApplication/?par=x HTTP/1.1
   Host: <no value or omitted>
   Cookie: bsApplSession=<unique BS data channel web session identity>
   Cookie: dcgwSession=<unique DCGW session identity>
6) DCGW forwards the received HTTP request to the DCSF as specified by the
   ‘dcgwSession’ cookie, using an available HTTP/2 stream:
   POST/myApplication?par=x HTTP/2
   Host: <DCSF 1>: 3365
   Cookie: bsApplSession=<unique BS data channel web session identity>

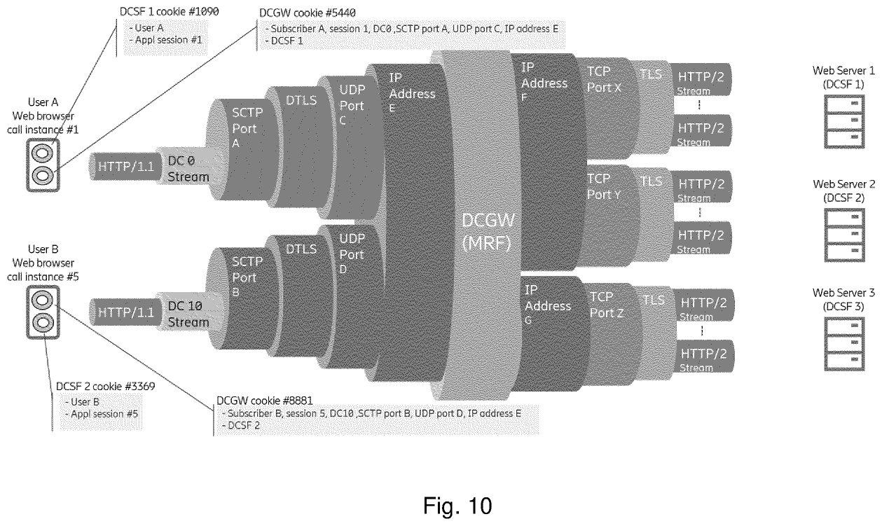

The following FIG. 10 presents an example on the representation of the cookies downloaded by a specific web browser instance of two different users, which are both served by one DCGW instance but different DCSF instances. Since the required context meta-data is carried by each HTTP request, it is possible for the DCGW to use any HTTP/2 stream of any existing TCP connection being connected with the target DCSF.

### Program Specification and Execution

BGDS Communication Services
3GPP 26.114 is showing establishment of a DC call:
1. Uploaded to the network, by a UE user or some other authorized party.
2. Stored in a data channel application repository in the network.
3. During the data channel Multimedia Telephony Service for IMS (DCMTSI) call where it should be used, retrieved from the repository.
4. Sent through a bootstrap data channel to the local UE A.
5. Sent through a bootstrap data channel to the remote UE B. This may happen in parallel with and rather independent of step 4.
6. Any additional data channels created and used by the data channel application itself are established, logically, between UE A and UE B. Data transmission on data channels shall not start until there is confirmation that both peers have instantiated the data channel, using the same procedures as described for. The traffic may effectively go through the Data Channel Server, e.g., when the bootstrap and end-to-end data channels have the same anchoring point. This traffic may pass across an inter-operator border if UE A and UE B belong to different operators' networks.

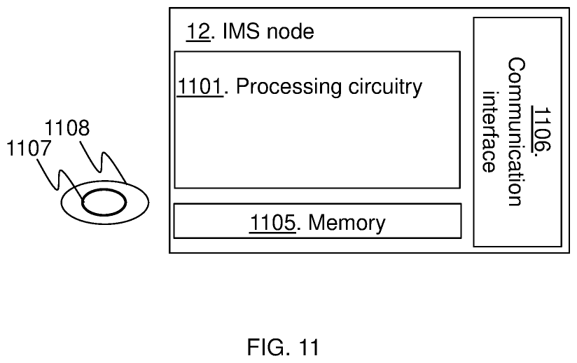

FIG. 11 is a schematic overview depicting the IMS node 12 such as an DCGW, for handling communication, of one or more UEs, in the communication network 1 according to embodiments herein.

The IMS node 12 may comprise processing circuitry 1101, e.g., one or more processors, configured to perform the methods herein.

The IMS node 12, and/or the processing circuitry 1101 is configured to add the indication to the request of the UE 10, wherein the request relates to the session of the IMS service, and wherein the indication identifies the user of the UE and the session. The indication may comprise meta data comprising one or more of the following: an identity related to the UE such as subscriber ID, an identity of a call session, and/or a bootstrap context. The session may comprise a bootstrap data channel web session.

The IMS node 12, and/or the processing circuitry 1101 is configured to transmit the request to the server 13 including the indication.

The IMS node 12, and/or the processing circuitry 1101 may be configured to receive from the server 13, an indication of routing information identifying the session such as a specific bootstrap data channel web session.

The IMS node 12, and/or the processing circuitry 1101 may be configured to store server routing information as meta-data within a hypertext transfer protocol, HTTP, layer, as the web cookie or another web cookie.

The IMS node 12, and/or the processing circuitry 1101 may be configured to transmit a response to the UE 10 and to append an indication identifying a server instance serving the session.

The IMS node 12, and/or the processing circuitry 1101 may be configured to receive from the UE 10 a subsequent request with another indication, i.e. the previously appended indication.

The IMS node 12, and/or the processing circuitry 1101 may be configured to forward the received subsequent request to the server as specified in the indication from the UE (10) with the indication of routing information.

The IMS node 12 further comprises a memory 1105. The memory 1105 comprises one or more units to be used to store data on, such as indications, web cookies, routing information, configurations, resource information, contact information, DC information, IMS information, session ID, UE information, and applications to perform the methods disclosed herein when being executed, and similar. Furthermore, the IMS node 12 may comprise a communication interface 1106 such as comprising a transmitter, a receiver and/or a transceiver.

The methods according to the embodiments described herein for the IMS node 12 are respectively implemented by means of e.g. a computer program product 1107 or a computer program, comprising instructions, i.e., software code portions, which, when executed on at least one processor, cause the at least one processor to carry out the actions described herein, as performed by the IMS node 12. The computer program product 1107 may be stored on a computer-readable storage medium 1108, e.g., a disc, a universal serial bus (USB) stick or similar. The computer-readable storage medium 1108, having stored thereon the computer program product, may comprise the instructions which, when executed on at least one processor, cause the at least one processor to carry out the actions described herein, as performed by the IMS node 12. In some embodiments, the computer-readable storage medium may be a transitory or a non-transitory computer-readable storage medium. Thus, embodiments herein may disclose an IMS node 12 for handling communication in a wireless communications network, wherein the IMS node 12 comprises processing circuitry and a memory, said memory comprising instructions executable by said processing circuitry whereby said IMS node 12 is operative to perform any of the methods herein.

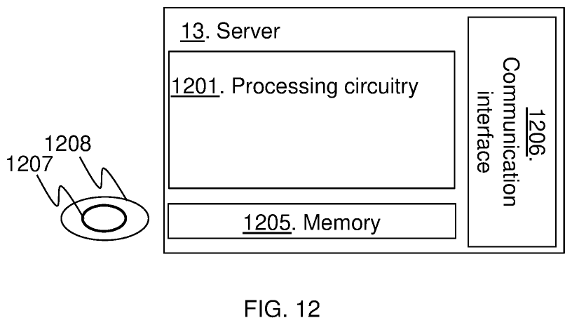

FIG. 12 is a schematic overview depicting the server 13 such as a DCSF for handling communication, of one or more UEs, in the communication network 1 according to embodiments herein.

The server 13 may comprise processing circuitry 1201, e.g. one or more processors, configured to perform the methods herein.

The server 13, and/or the processing circuitry 1201 is configured to receive from the IMS node 12, the request of the UE 10 with an indication, wherein the request relates to a session of an IMS service, and wherein the indication identifies a user of the UE and the session. The session may comprise a bootstrap data channel web session.

The server 13, and/or the processing circuitry 1201 may be configured to create routing information, such as a web cookie, identifying the session. The server 13, and/or the processing circuitry 1201 may be configured to transmit to the IMS node 12, the indication of the created routing information, for example, transmit the web cookie.

The server 13, and/or the processing circuitry 1201 may be configured to receive the subsequent request from the IMS node 12, comprising the indication of the created routing information.

The server 13 further comprises a memory 1205. The memory 1205 comprises one or more units to be used to store data on, such as indications, IMS information, Resource information, session ID, contact information, thresholds, data related to nodes, and applications to perform the methods disclosed herein when being executed, and similar. Furthermore, the server 13 may comprise a communication interface 1206 such as comprising a transmitter, a receiver and/or a transceiver, and/or one or more antennas. The methods according to the embodiments described herein for the server 13 are respectively implemented by means of e.g. a computer program product 1207 or a computer program, comprising instructions, i.e., software code portions, which, when executed on at least one processor, cause the at least one processor to carry out the actions described herein, as performed by the server 13. The computer program product 1207 may be stored on a computer-readable storage medium 1208, e.g. a disc, a universal serial bus (USB) stick or similar. The computer-readable storage medium 1208, having stored thereon the computer program product, may comprise the instructions which, when executed on at least one processor, cause the at least one processor to carry out the actions described herein, as performed by the server 13. In some embodiments, the computer-readable storage medium may be a transitory or a non-transitory computer-readable storage medium. Thus, embodiments herein may disclose a server 13 for handling communication in a wireless communications network, wherein the server 13 comprises processing circuitry and a memory, said memory comprising instructions executable by said processing circuitry whereby said server 13 is operative to perform any of the methods herein.

In some embodiments a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system.

Examples of UE are IoT capable device, target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate actions, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein.

As such, the apparatus and techniques taught herein are not limited by the foregoing description and accompanying drawings. Instead, the embodiments herein are limited only by the following claims and their legal equivalents.

1. A method performed by an Internet Protocol Multimedia Subsystem (IMS) node for handling communication in a communication network, the method comprising:
adding an indication to a request of a user equipment (UE) wherein the request relates to a session of an IMS service, and wherein the indication identifies a user of the UE and the session; and
transmitting the request to a server including the indication.

2. The method according to claim 1, wherein the indication comprises meta data comprising one or more of the following: an identity related to the UE, an identity of a call session, and a bootstrap context.

3. The method according to claim 1, wherein the session comprises a bootstrap data channel web session.

4. The method according to claim 1, further comprising:
receiving from the server an indication of routing information identifying the session.

5. The method according to claim 1, further comprising:
storing server routing information as meta-data within a hypertext transport protocol (HTTP) layer.

6. The method according to claim 1, further comprising:
transmitting a response to the UE with an appended indication identifying a server instance serving the session.

7. The method according to claim 6, further comprising:
receiving from the UE a subsequent request with the appended indication.

8. The method according to claim 7, further comprising:
forwarding the received subsequent request to the server as specified in the indication from the UE with the indication of routing information from the server.

9. A method performed by a server for handling communication in a communication network, the method comprising:
receiving, from an Internet Protocol Multimedia Subsystem (IMS) node, request of a user equipment (UE) with an indication, wherein the request relates to a session of an IMS service, and wherein the indication identifies a user of the UE and the session.

10. The method according to claim 9, wherein the session comprises a bootstrap data channel web session.

11. The method according to claim 9, further comprising:
creating routing information identifying the session; and
transmitting to the IMS node an indication of the created routing information.

12. The method according to claim 11, further comprising:.
receiving a subsequent request from the IMS node comprising the indication of the created routing information.

13. An Internet Protocol Multimedia Subsystem (IMS) node for handling communication in a communication network, wherein the IMS node is configured to:
add an indication to a request of a user equipment (UE), wherein the request relates to a session of an IMS service, and wherein the indication identifies a user of the UE and the session; and
transmit the request to a server including the indication.

14. The IMS node according to claim 13, wherein the indication comprises meta data comprising one or more of following: an identity related to the UE, an identity of a call session, and bootstrap context.

15. A server for handling communication in a communication network, wherein the server is configured to:
receive, from an Internet Protocol Multimedia Subsystem (IMS) node, a request of a user equipment (UE) with an indication, wherein the request relates to a session of an IMS service, and wherein the indication identifies a user of the UE and the session.

16. The server according to claim 15, wherein the session comprises a bootstrap data channel web session.

17. A computer program product comprising instructions, which, when executed on at least one processor, cause the at least one processor to carry out the method according to:
add an indication to a request of a User Equipment (UE) wherein the request relates to a session of an Internet Protocol Multimedia Subsystem (IMS ) service, and wherein the indication identifies a user of the UE and the session; and
transmit the request to a server including the indication.

18. A computer-readable storage medium, having stored thereon a computer program product comprising instructions which, when executed on at least one processor, cause the at least one processor to:
add an indication to a request of a User Equipment (UE) wherein the request relates to a session of an Internet Protoc Multimedia Subsystem (MS) service, and wherein the indication identifies a user of the UE and the session; and
transmit the request to a server including the indication.
